(19) United States
(12) Patent Application Publication
(10) Pub. No.: US 2005/0036060 A1
(43) Pub. Date: Feb. 17, 2005

(54) Pixel reordering and selection logic prior to buffering

(76) Inventors: Mallinath Hatti, Bangalore (IN); Lakshmanan Ramakrishnan, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/799,032

(22) Filed: Mar. 12, 2004

Related U.S. Application Data
(60) Provisional application No. 60/495,695, filed on Aug. 14, 2003.

(51) Int. Cl. H04N 11/20

(52) U.S. Cl. 348/441; 348/554; 348/453

(57) ABSTRACT

Presented herein are systems and methods for pixel reordering and selection. A decoded picture is stored in a frame buffer with a particular pixel order and byte order. A input data write unit fetches portions of the decoded picture and stores portions of the picture in a double buffer with the same pixel order and byte order. An endian swizzle converts the byte ordering to a predetermined format, as needed. Reordering logic changes the pixel order to a predetermined order. Selection logic selects luma and chroma pixels from fetched pixels and provides the luma pixels to a luma pixel register, chroma Cr pixels to a chroma Cr pixel register, and chroma Cb pixels to a chroma Cb pixel register.

### RELATED APPLICATIONS

This application claims priority to Provisional Application for U.S. Patent, App. Ser. No. 60/495,695, entitled “LINE ADDRESS COMPUTER FOR FACILITATING CHROMA CONVERSION”, filed Aug. 14, 2003, by Hatti, which is incorporated herein by reference.

This application is also related to U.S. Patent Application Ser. No. 60/495,301, entitled “PIXEL REORDERING LOGIC FOR MULTIPLE FORMATS IN A FEEDER”, filed Aug. 14, 2003, by Hatti, et. al., which is incorporated herein by reference.

This application is also related to the following U.S. Patent Applications, each of which are incorporated herein by reference:

“Line Address Computer for Decoding the Line Addresses of Decoded Video Data”, U.S. patent application Ser. No. 10/703,332, filed Nov. 7, 2003 by Hatti, et. al., and claiming priority to Provisional Application for Patent Ser. No. 60/495,695.

“Pixel Reordering and Selection Logic”, U.S. patent application Ser. No. 10/712,482, filed Nov. 13, 2003 by Hatti, et. al., and claiming priority to Provisional Application for Patent Ser. No. 60/495,301.

“Line Address Computer for Providing Coefficients to Chroma Filter”, U.S. patent application Ser. No. 10/712,638, filed Nov. 13, 2003 by Hatti, and claiming priority to Provisional Application for Patent Ser. No. 60/495,695.

“Line Address Computer for Providing Line Addresses in Multiple Contexts”, U.S. patent application Ser. No. 10/714,833, filed Nov. 14, 2003 by Hatti, and claiming priority to Provisional Application for Patent Ser. No. 60/495,695.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

A video decoder receives encoded video data and decodes and/or decompresses the video data. The decoded video data comprises a series of pictures. A display device displays the frames. The pictures comprise a two-dimensional grid of pixels. The display device displays the pixels of each picture in real time at a constant rate. In contrast, the rate of decoding can vary considerably for different video data. Accordingly, the video decoder writes the decoded pictures in a frame buffer.

Among other things, a display engine is synchronized with the display device and provides the appropriate pixels to the display device for display. The display engine provides the appropriate pixels from the frame buffer to the display device. The location of the appropriate pixels in the frame buffer is dependent on the manner that the video decoder writes the picture to the frame buffer.

Characteristics that characterize the manner that the video decoder writes the picture to the frame buffer include the packing of luma and chroma pixels, the linearity that the picture is stored, and the spatial relationship between the luma and chroma pixels. The foregoing characteristics are usually determined by the original format of the source video data.

The luma and chroma pixels of a picture can either be stored together or separately. The chroma pixels include chroma red difference pixels Cr, and chroma blue difference pixels Cb. In MPEG, DV25, and TM5, the luma Y pixels are stored in one array, while both chroma pixels Cr/Cb are stored together in another array. In planar, the luma pixels Y are stored in one array, the Cr pixels are stored in a second array, and the Cb pixels are stored in a third array. In packed YUV, the luma pixels and both the chroma Cr/Cb pixels are stored together in a single array.

In the packed YUV format, each alternating luma Y pixel is co-located with chroma pixels Cr/Cb in the horizontal direction. A picture in the packed YUV format can be divided into units of four pixels, each of the units capable of being stored in a 32-bit word. The four pixels comprise adjacent luma Y pixels and the chroma pixels Cr/Cb co-located with one of the luma Y pixels. The luma Y pixels and the chroma pixels Cr/Cb can be packed in any one of several pixel orders. Examples of pixel orders that the luma Y pixels and chroma pixels Cr/Cb can be packed include, (Cb₀,Y₀,Cr₀,Y₁), (Cr₀,Y₀,Cb₀,Y₁), (Y₀,Cb₀,Y₁,Cr₀), and (Y₀,Cr₀,Y₁,Cb₀). Additionally, in big endian order, the four bytes are stored in a 32-bit dword as (byte0,byte1,byte2,byte3). In little endian order, the four bytes are stored as byte3/byte2/byte1/byte0. Whether bytes are stored in big endian byte order or little endian byte order depends on the system endianess.

The video decoder does not necessarily store the picture in a linear manner. In planar and packed YUV, the video decoder stores pictures in left to right and top to bottom order in the memory. However, in MPEG, DV25, and TM5, pictures are stored in the frame buffer in a macroblock format. In the macroblock format, the pixels of the picture are divided into two dimensional blocks. The video decoder stores the two dimensional blocks in consecutive memory locations.

Additionally, the spatial relationship of chroma pixels to luma pixels can differ among the many standards. Standards defining the spatial relationship of the chroma pixels to luma pixels include MPEG 4:2:0, MPEG 4:2:2, DV-25 4:2:0, and TM5 4:2:0, to name a few. Where the standards for the display and the decoded video data differ, chroma pixels for the display can be interpolated from two or more chroma pixels in the decoded video data. The chroma interpolation heavily dependent on the format of the source video data.

Conventionally, after each horizontal synchronization pulse, the host processor calculates the address of the first pixels of a line and the parameters for chroma format conversion. The host processor then programs the display engine with the foregoing.

Programming the display engine at each horizontal synchronization pulse consumes considerable bandwidth from the host processor.

Further limitations and disadvantages of conventional and traditional approaches will become apparent to one of skill in the art, through comparison of such systems with embodiments presented in the remainder of the present application with references to the drawings.

### BRIEF SUMMARY OF THE INVENTION

Presented herein is a line address computer for calculating the line addresses of decoded video data.

In one embodiment, there is presented a method for displaying pictures. The method comprises fetching a portion of a picture stored in a frame buffer, the portion of the picture being stored with a byte order, converting the byte order of the portion of the picture to a predetermined byte order, the byte order being different from the predetermined byte order, and storing the portion of the picture in another buffer with the predetermined byte order.

In another embodiment, there is presented a system for displaying pictures. The system comprises a first circuit, a second circuit, and a buffer. The first circuit fetches a portion of a picture stored in a frame buffer, the portion of the picture being stored with a byte order. The second circuit converts the byte order of the portion of the picture to a predetermined byte order, the byte order being different from the predetermined byte order. The buffer stores the portion of the picture with the predetermined byte order.

In another embodiment, there is presented a method for displaying pictures. The method comprises fetching a portion of a picture stored in a frame buffer, the portion of the picture being stored with a pixel order, converting the pixel order of the portion of the picture to a predetermined pixel order, and storing the portion of the picture in another buffer with the predetermined pixel order.

In another embodiment, there is presented a system for displaying pictures. The system comprises an input data write unit, a circuit, and a buffer. The input data write unit fetches a portion of a picture stored in a frame buffer, the portion of the picture being stored with a pixel order. The circuit converts the pixel order of the portion of the decoded picture to a predetermined pixel order. The buffer portion of the picture with the predetermined pixel order.

In another embodiment, there is presented a method for displaying pictures. The method comprises fetching a portion of a picture stored in a frame buffer, said portion of the picture comprising a plurality of pixels, storing luma pixels in a luma pixel register, if the plurality of pixels comprise luma pixels, storing chroma pixels in a chroma pixel register, if the plurality of pixels comprise chroma pixels, and storing the contents of the chroma pixel register in one portion of another buffer and the contents of the luma pixel register in another portion of the another buffer.

In another embodiment, there is presented a system for displaying pictures. The system comprises a first circuit, a luma pixel register, a chroma pixel register, and another buffer. The first circuit fetches a portion of a picture stored in a frame buffer, the portion of the picture comprising a plurality of pixels. The luma pixel register stores luma pixels, if the plurality of pixels comprise luma pixels. The chroma pixel register stores chroma pixels, if the plurality of pixels comprise chroma pixels. The another buffer stores the portion of the picture.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is block diagram of an exemplary decoder system in accordance with an embodiment of the present invention;

FIG. 2 is a block diagram of an exemplary frame;

FIG. 3A is a block diagram of a frame buffer storing a frame in accordance with the MPEG, DV25 and TM5 formats;

FIG. 3B is a block diagram of a frame buffer storing a frame in accordance with the packed YUV format;

FIG. 3C is a block diagram of a frame buffer storing a frame in accordance with the planar format;

FIG. 4A is a block diagram of an exemplary gword storing packed YUV data in big endian byte order;

FIG. 4B is a block diagram of an exemplary gword storing packed YUV data in little endian byte order;

FIG. 5A is a block diagram of an exemplary gword storing MPEG/DV-25/TM5 pixels in big endian byte order;

FIG. 6 is a block diagram of an exemplary display engine in accordance with an embodiment of the present invention;

FIG. 7 is a block diagram of a pixel feeder in accordance with an embodiment of the present invention;

FIG. 8 is a block diagram of the luma/chroma pixel separator and Gword packer in accordance with an embodiment of the present invention;

FIG. 9 is a block diagram of an endian swizzle in accordance with an embodiment of the present invention; and

FIG. 10 is a block diagram of pixel select logic in accordance with an embodiment of the present invention.

### DETAILED DESCRIPTION OF THE INVENTION

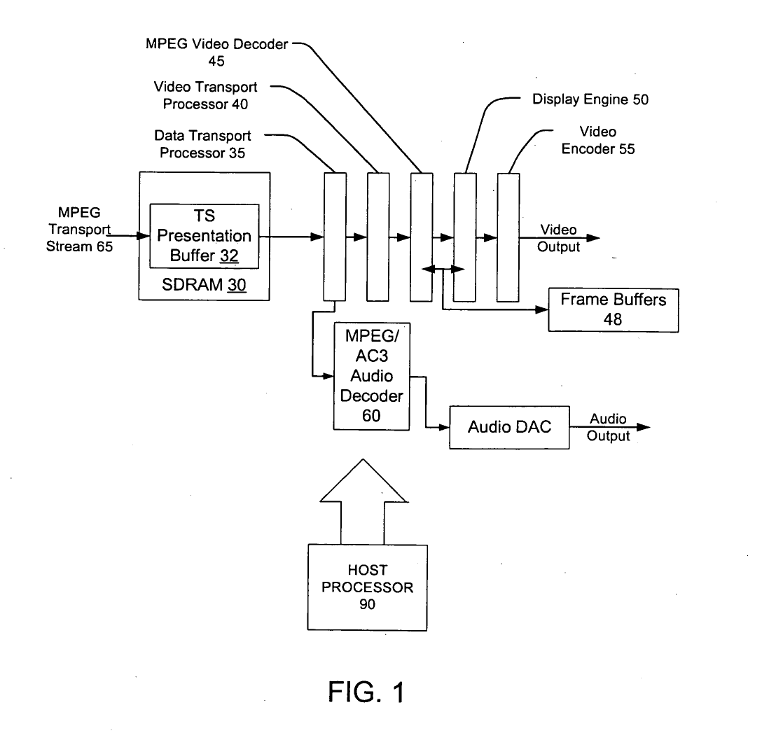

Referring now to FIG. 1, there is illustrated a block diagram of an exemplary decoder system for decoding compressed video data, configured in accordance with an embodiment of the present invention. A processor, that may include a CPU 90, reads transport stream 65 into a transport stream buffer 32 within an SDRAM 30.

The data is output from the transport stream buffer 32 and is then passed to a data transport processor 35. The data transport processor 35 then demultiplexes the transport stream 65 into constituent transport streams. The constituent packetized elementary stream can include for example, video transport streams, and audio transport streams. The data transport processor 35 passes an audio transport stream to an audio decoder 60 and a video transport stream to a video transport processor 40.

The video transport processor 40 converts the video transport stream into a video elementary stream and provides the video elementary stream to a video decoder 45. The video decoder 45 decodes the video elementary stream, resulting in a sequence of decoded video frames. The decoding can include decompressing the video elementary stream. It is noted that there are various standards for compressing the amount of data required for transportation and storage of video data, such as MPEG-2 for example.

The decoded video data includes a series of frames. The frames are stored in a frame buffer 48. The frame buffer 48 can be dynamic random access memory (DRAM) comprising 128 bit/16 byte gigantic words (gwords). It is also noted that in certain standards, such as MPEG-2, the order that pictures are decoded is not necessarily the order that pictures are presented. Accordingly, several pictures can be stored in the frame buffer 48 at a given time.

The display engine 50 is responsible for providing a bitstream to a display device, such as a monitor or a television. A display device displays the pictures in a specific predetermined display format with highly synchronized timing. The format dictates the order that different portions of a picture are displayed, as well as the positions of pixels.

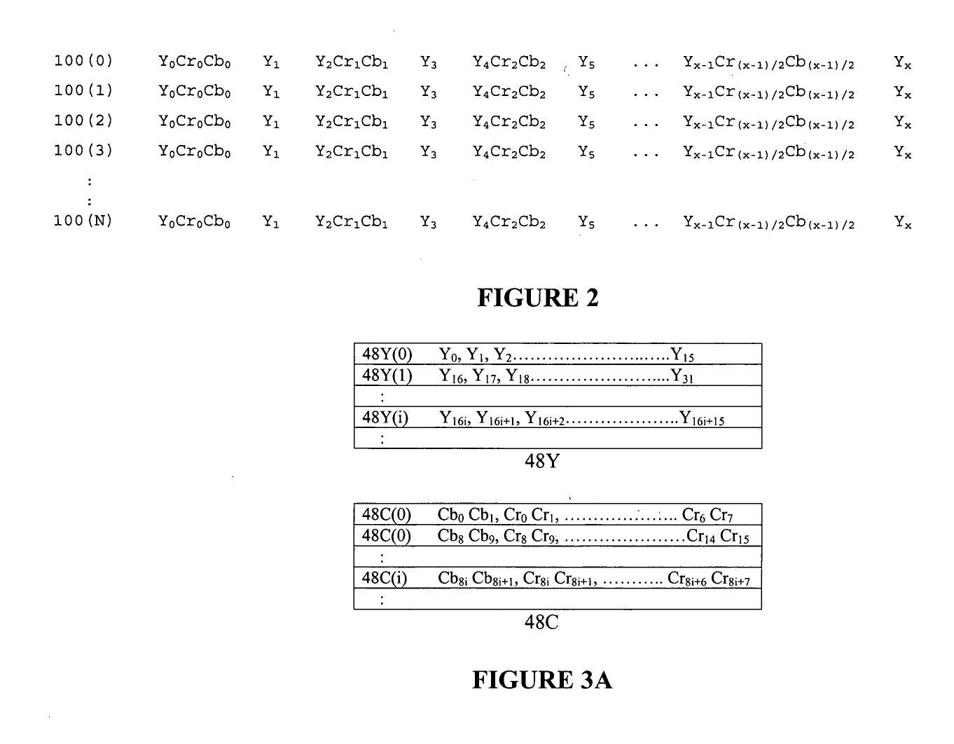

Referring now to FIG. 2, there is illustrated a block diagram describing an exemplary frame 100. The frame 100 comprises any number of horizontal rows 100(0) . . . 100(N). Each row 100(0) . . . 100(N) includes a row of luma Y pixels, Y₀ . . . Yₓ, and half as many chroma Cr pixels Cr₀ . . . Cr_{(x-1)/2} and half as many chroma Cb pixels Cb₀ . . . Cb_{(x-1)/2}. In a standard definition television frame 100, there are 480 rows (N=479), each comprising 720 luma Y pixels, 360 chroma Cr pixels, and 360 chroma Cb pixels.

The luma Y, chroma Cr, and chroma Cb pixels can be stored in one of several array formats. For example, in the packed YUV format, the luma Y, chroma Cr, and chroma Cb pixels are stored together in one array. In the planar format, the luma pixels, chroma Cr pixels, and chroma Cb pixels are each stored in separate arrays. In MPEG, DV25, and TM5, the luma pixels Y are stored in one array, while the chroma Cr and chroma Cb pixels are stored together in another array.

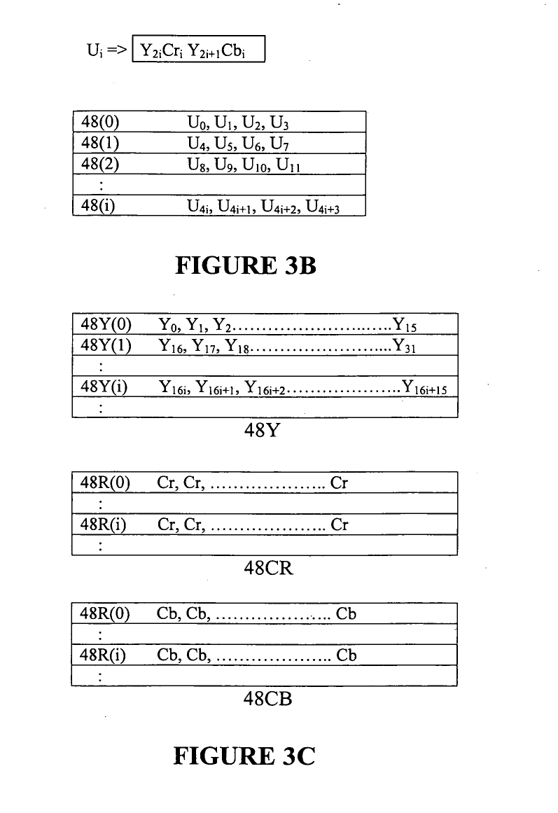

Referring now to FIG. 3A, there is illustrated a block diagram describing the frame buffer storing the frame 100 in accordance with an array format for the MPEG, DV25 and TM5 formats. The frame buffer 48 comprises two arrays 48Y, 48C of 16 byte/128 bit gwords 48Y(0), 48Y(1), 48Y(2), . . . , and 48C(0), 48C(1), 48C(2), . . . . The pixels luma pixels Y are stored in array 48Y. The chroma Cr and Cb pixels are stored in array 48C. The gwords 48Y(0), 48Y(1), . . . each store 16 horizontally adjacent luma pixels, Y₁₆ᵢ . . . Y₁₆ᵢ₊₁₅. Each gword in array 48Y is associated with a gword in array 48C, wherein the associated gword in array 48C stores the chroma Cr and chroma Cb pixels co-located with the luma pixels Y₁₆ᵢ . . . Y₁₆ᵢ₊₁₅.

Referring now to FIG. 3B, there is illustrated a block diagram describing the frame buffer 48 storing frame 100 in accordance with the packed YUV array format. The frame buffer 48 comprises 16 byte/128 bit gwbrds 48(0), 48(1), 48(2), . . . . The pixels Y₀ . . . Yₓ, Cr₀ . . . Cr_{(x-1)/2} in each row of the frame 100(0) . . . 100(N) are divided into units of four pixels U₀ . . . U_{(x-1)/2}. Each unit Uᵢ comprises two luma pixels Y₂ᵢ and Y₂ᵢ₊₁, and the chroma Crᵢ and chroma Cbᵢ pixels co-located with luma pixels Y₂ᵢ. The units U of each row 100(0) . . . 100(N) are stored from left to right U₀ . . . U_{(x-1)/2} in consecutive four byte memory portions. The gwords 48(0), 48(1), . . . can store four units U₄ᵢ, U₄ᵢ₊₁, U₄ᵢ₊₂, U₄ᵢ₊₃, therein. The four pixels Y₂ᵢ, Y₂ᵢ₊₁, Crᵢ, Cbᵢ can be stored into four bytes in one of pixel orders, including, Cbᵢ Y₂ᵢ Crᵢ Y₂ᵢ₊₁, Crᵢ Y₂ᵢ Cbᵢ Y₂ᵢ₊₁, Y₂ᵢ Crᵢ Y₂ᵢ₊₁Cbᵢ, and Y₂ᵢ Cbᵢ Y₂ᵢ₊₁Crᵢ.

Referring now to FIG. 3C, there is illustrated a block diagram describing the frame buffer 48 storing frame 100 in accordance with the planar format. The frame buffer 48 comprises three arrays 48Y, 48CR, 48CB of 16 byte/128 bit gwords 48Y(0), 48Y(1), 48Y(2), . . . , and 48C(0), 48C(1), 48C(2), . . . . The luma pixels Y are stored in array 48Y. The chroma Cr are stored in array 48CR. The chroma Cb pixels are stored in array 48CB. The gwords 48Y(0), 48Y(1), . . . each store 16 horizontally adjacent luma pixels, Y₁₆ᵢ . . . Y₁₆ᵢ₊₁₅ Each gword in array 48Y is associated with a gword half in array 48CR, and a gword half in array 48CB, wherein the associated gword half in array 48CR and array 48CB store the chroma Cr and chroma Cb pixels co-located with the luma pixels Y₁₆ᵢ . . . Y₁₆ᵢ₊₁₅.

The pixels can either be written in big endian byte order, byte0,byte1,byte2,byte3 or little endian byte order byte3,byte2,byte1,byte0.

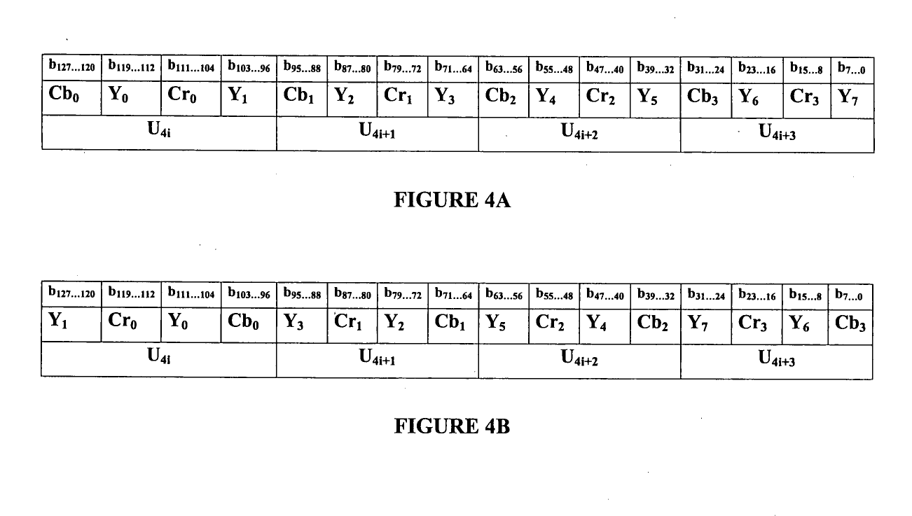

Referring now to FIG. 4A, there is illustrated a block diagram of an exemplary gword 48(i) storing data in big endian byte order. The gword 48(i) comprises 128 bits, b₁₂₇ . . . b₀. In big endian byte order, bytes are stored starting from bits b₁₂₇ . . . b₁₂₀. The units U₄ᵢ, U₄ᵢ₊₁, U₄ᵢ₊₂, U₄ᵢ₊₃ are stored in bits b₁₂₇ . . . b₉₆, b₉₅ . . . b₆₄, b₆₃ . . . b₃₂, b₃₁ . . . b₀, respectively. Additionally, the first, second, third, and fourth pixel of unit U₄₊₃ are stored in bits b₃₁ . . . b₂₄, b₂₃ . . . b₁₆, b₁₅ . . . b₈, and b₇ . . . bₒ, respectively. If the pixels of units U₄ᵢ, U₄ᵢ₊₁, U₄ᵢ₊₂, U₄ᵢ₊₃ are in the pixel order Cb₀,Y₀,Cr₀,Y₁, the chroma Cb pixels in units U₄ᵢ, U₄ᵢ₊₁, U₄ᵢ₊₂, U₄ᵢ₊₃ are stored in bits b₁₀₃ . . . b₉₆, b₇₁ . . . b₆₄, b₃₉ . . . b₃₂, and b₇ . . . b₀ respectively. The first luma pixels (that are co-located with the chroma Cr and Cb pixels) Y₀ of units U₄ᵢ, U₄ᵢ₊₁, U₄ᵢ₊₂, U₄ᵢ₊₃ are stored in bits b₁₁₁ . . . b₁₀₄, b₇₉ . . . b₇₂, b₄₇ . . . b₄₀,and b₁₅ . . . b₈, respectively. The chroma Cr pixels in units U₄ᵢ, U₄ᵢ₊₁, U₄ᵢ₊₂, U₄ᵢ₊₃ are stored in bits b₁₁₉ . . . b₁₁₂, b₈₇ . . . b₈₀, b₅₅ . . . b₄₈, and b₂₃ . . . b₁₆, respectively. The second luma pixels (that are co-located with the chroma Cr and Cb pixels) Y₁ of units U₄ᵢ, U₄ᵢ₊₁, U₄ᵢ₊₂, U₄ᵢ₊₃ are stored in bits b₁₂₇ . . . b₁₂₀, b₉₅ . . . b₈₈, b₆₃ . . . b₅₆,and b₃₁ . . . b₂₄, respectively.

Referring now to FIG. 4B, there is illustrated a block diagram of an exemplary gword 48(i) storing data in little endian byte order. The gword 48(i) comprises 128 bits, b₁₂₇ . . . b₀. In little endian byte order, bytes are stored starting from bits b₁₂₇ . . . b₁₂₀. The units U₄ᵢ, U₄ᵢ₊₁, U₄ᵢ₊₂, U₄ᵢ₊₃ are stored in bits b₁₂₇ . . . b₉₆, b₉₅ . . . b₆₄, b₆₃ . . . b₃₂, b₃₁ . . . b₀, respectively. Additionally, the first, second, third, and fourth pixel of unit U₄ᵢ are stored in bits b₁₂₇ . . . b₁₂₀, b₁₁₉ . . . b₁₁₂, b₁₁₁ . . . b₁₀₄, are b₁₀₃ . . . b₉₆, respectively. If the pixels of units U₄ᵢ, U₄ᵢ₊₁, U₄ᵢ₊₂, U₄ᵢ₊₃ are in the pixel order Cb, Y₀, Cr, Y₁, the chroma Cb pixels in units U₄ᵢ, U₄ᵢ₊₁, U₄ᵢ₊₂, U₄ᵢ₊₃ are stored in bits b₁₀₃ . . . b₉₆, b₇₁ . . . b₆₄, b₃₉ . . . b₃₂, and b₇ . . . b₀, respectively. The first luma pixels (that are co-located with the chroma Cr and Cb pixels) Y₀ of units U₄ᵢ, U₄ᵢ₊₁, U₄ᵢ₊₂, U₄ᵢ₊₃ are stored in bits b₁₁₁ . . . b₁₀₄, b₇₉ . . . b₇₂, b₄₇ . . . b₄₀, and b₁₅ . . . b₈, respectively. The chroma Cr pixels in units U₄ᵢ, U₄ᵢ₊₁, U₄ᵢ₊₂, U₄ᵢ₊₃ are stored in bits b₁₁₉ . . . b₁₁₂, b₈₇ . . . b₈₀, b₅₅ . . . b₄₈, and b₂₃ . . . b₁₆, respectively. The second luma pixels (that are co-located with the chroma Cr and Cb pixels) Y₁ of units U₄ᵢ, U₄ᵢ₊₁, U₄ᵢ₊₂, U₄ᵢ₊₃ are stored in bits b₁₂₇ . . . b₁₂₀, b₉₅ . . . b₈₈, b₆₃ . . . b₅₆,and b₃₁ . . . b₂₄, respectively.

From the foregoing, it can be seen that the 32-bits storing a unit U are different. Additionally, in big endian, the lowest order bits store the first pixel while in little endian, the highest order bits store the first pixel.

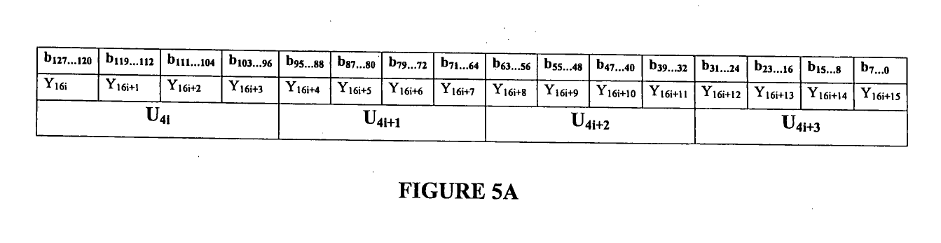

Referring now to FIG. 5A, there is illustrated a block diagram of an exemplary gword 48(i) storing data in big endian byte order. The gword 48(i) comprises 128 bits, b₁₂₇ . . . b₀. In big endian order, bytes are stored starting from bits b₁₂₇ . . . b₁₂₀. For pixels Y₁₆ᵢ . . . Y₁₆ᵢ₊₁₅, the pixel Y₁₆ᵢ is stored in bits b₁₂₇ . . . b₁₂₀, The pixel Y₁₆ᵢ₊₁ is stored in bits b₁₁₉ . . . b₁₁₂, the pixel Y₁₆ᵢ₊₂ is stored in bits b₁₁₁ . . . b₁₀₄, the pixel Y₁₆ᵢ₊₃ is stored in bits b₁₀₃ . . . b₉₆, and the pixel Y₁₆ᵢ₊₁₅ is stored in bits b₇ . . . b₀. For pixels Cr/Cb₈ᵢ . . . Cr/Cb₈ᵢ₊₇, the pixel Cb₈ᵢ is stored in bits b₁₂₇ . . . b₁₂₀, pixel Cb₈ᵢ₊₁ is stored in bits b₁₁₉ . . . b₁₁₂, pixel Cr₈ᵢ is stored in bits b₁₁₁ . . . b₁₀₄, pixel Cr₈ᵢ₊₁ is stored in bits b₁₀₃ . . . b₉₆, pixel Cb₈ᵢ₊₇ is stored in bits b₂₃ . . . b₁₆, pixel Cr₈ᵢ₊₇ is stored in bits b₇ . . . b₀.

The display device is usually separate from the decoder system. The display device displays the frames with highly synchronized timing. Each row 100(0) . . . 100(N) is displayed at a particular time interval. The display engine 50 provides the pixels to the display device for display, via the video encoder. The display device and the display engine 50 are synchronized by means of a vertical synchronization pulses and horizontal synchronization pulses. When the display device begins displaying a new frame 100 or field, the display device transmits a vertical synchronization pulse. Each time the display device begins displaying a new line 100(x), the display device sends a horizontal synchronization pulse. The display engine 50 uses the horizontal and vertical synchronization pulses to provide a bitstream comprising the pixels at a time related to the time for display.

The display engine 50 generates the bitstream from the decoded pictures stored in the frame buffers 48. To generate the bitstream of the pixels for display on the display device, the display engine 50 fetches the pixels from the frame buffer 48. However, the decoded pictures may be progressive while the display device is interlaced. Additionally, the decoded picture may have chroma pixels in different positions from the display format. Additionally, the pixels of the decoded picture may be stored in a variety of different ways. For example, the chroma pixels can either be stored separately or with the luma pixels.

Where the decoded picture has a different chroma format from the display format, the chroma pixels for the chroma pixel positions in the display format are interpolated from the chroma format of the decoded picture.

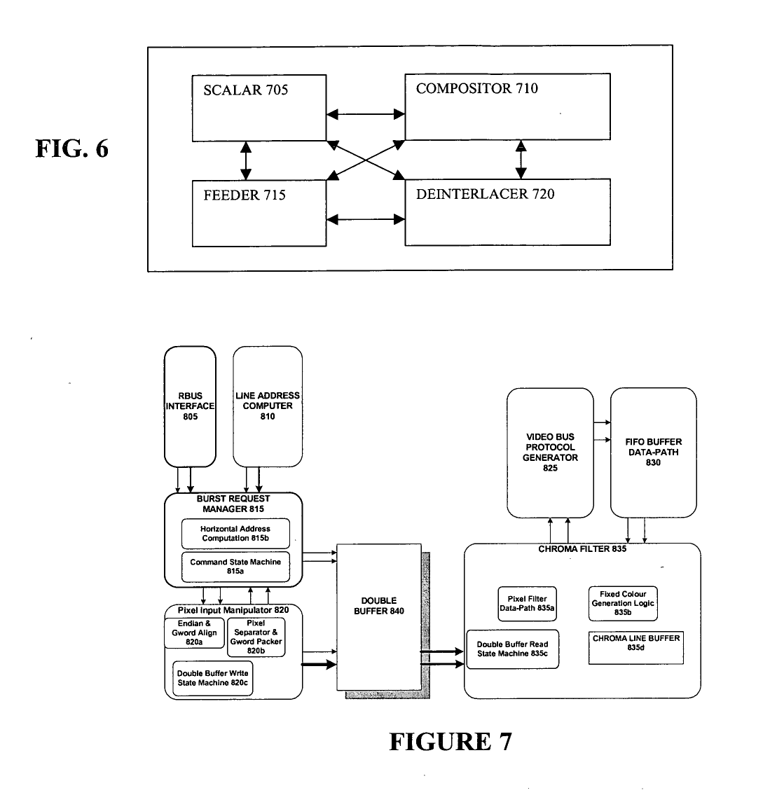

Referring now to FIG. 6, there is illustrated a block diagram of the display engine 50 in accordance with an embodiment of the present invention. The display engine 50 includes a scaler 705, a compositor 710, a feeder 715, and a deinterlacing filter 720. The feeder 715 provides a bitstream of the pixels in the order the pixels are displayed for the display device. The bitstream comprises chroma pixels in the chroma pixel positions of the display format.

Referring now to FIG. 7, there is illustrated a block diagram describing an exemplary feeder 715 in accordance with an embodiment of the present invention. The feeder 715 provides a bitstream comprising pixels for display on the display device. The bitstream provides the pixels for display on the display device at a time related to the time the pixels are to be displayed by the display device. Additionally, the bitstream comprises chroma pixels in the chroma pixel positions in accordance with the display format. After each horizontal synchronization pulse, a row 100(x) is presented to the display device 65 for display.

After each vertical synchronization pulse, the host processor 90 programs the feeder 715 with the addresses of the frame buffer memory locations storing the first luma pixels, the first chroma pixel(s) for display (i.e., the left most pixels in row 100(0)), and the format of the decoded frame.

The foregoing parameters are provided to the feeder 715 via the RBUS interface 805. After providing the parameters to the RBUS interface 805, the host 90 sets a start parameter in the RBUS interface 805.

The RBUS interface 805 provides the initial starting luma and chroma addresses to the BRM 815. When the BRM 815 receives the starting luma and chroma addresses, the start parameter in the RBUS interface 805 is deasserted. The BRM 815 issues the commands for fetching the luma and chroma pixels in the first line of the frame/field. The IDWU 820 effectuates the commands.

The BRM 815 includes a command state machine 815a and horizontal address computation logic 815b. The command state machine 815a can issue commands to the IDWU 820 causing the feeder 715 to fetch pixels from the frame buffer at a memory address provided by the command state machine 815a. The command state machine initially commands the IDWU 820 to fetch the pixels starting at the starting luma and chroma addresses. The horizontal computation logic 815b maintains the address of the frame buffer 48 location storing the next pixels in the display order.

The IDWU 820 comprises an endian swizzle & pixel select logic 820a, a write data path 820b, and a double buffer state machine 820c. The IDWU 820 writes the fetched pixels to a double buffer 840 until the double buffer 840 is full. After the double buffer 840 is full, the double buffer state machine detects when half of the data in the double buffer 840 is consumed. Responsive thereto, the command state machine 815a commands the IDWU 820 to fetch the next pixels in the display order, starting at the address calculated by the horizontal address computation logic 815b, until the double buffer 840 is full. The foregoing continues for each pixel in the first line 100(0).

A line address computer 810 calculates the address of the memory locations storing the starting pixels of the next line, e.g., line 100(1) if a progressive display or line 100(2) if an interlaced display. The BRM 815 causes the IDWU 820 to start fetching pixels from the provided starting address. For each horizontal synchronization pulse, the line address computer 810 provides the address of the memory locations storing the first pixel (leftmost) of a row of luma pixels. The line address computer 810 provides the address storing the first pixel of consecutive rows of luma pixels 100(0), 100(1), . . . , 100(N) if the display is progressive. The line address computer 810 provides the address storing the first pixel of alternating rows of luma pixels 100(0), 100(2), . . . , 100(N-1), 100(1), 100(3) . . . 100(N) if the display device 65 is interlaced. The line address computer 810 is described in more detail in “Line Address Computer for Calculating the Line Addresses of Decoded Video Data”, U.S. patent application Ser. No. 10/703,332, filed Nov. 7, 2003, by Hatti, et. al. (Attorney Docket No. 15139US01), which is incorporated herein by reference.

A pixel feeder 835 comprises a chroma filter data path 835b, a chroma line buffer 835c, an output data path 835d, fixed color generation logic 835e, and a double buffer read state machine 835f. The double buffer state machine 835f performs various duties that manage the pixel feeder 835. The duties include maintaining the double-buffer 840 status, reading pixels from the double buffer 840, sequencing the chroma filter datapath 835b, and loading pixels onto the FIFO 830.

The double buffer read state machine 835f creates a rasterized data stream from the pixel data stored in the double buffer 840. The stream comprises a luma pixel bitstream and the chroma pixel bitstream(s) that are synchronized with respect to each other, such that the luma pixels in the bitstream at a particular time and the chroma pixels in the bitstream(s) at a particular time are either co-located, or the pixels for interpolating the chroma pixels at chroma pixel positions are co-located with the luma pixels.

The pixel feeder 835 interpolates chroma pixels for the chroma pixel positions in the display frame from the pixels in the decoded frame. At each horizontal synchronization pulse, the line address computer 810 provides interpolation weights, WCbT, WCbB, WCrT, and WCrB for interpolation to the chroma filter data path 835b. The interpolation weights depend on the decoded frame format, the display format, and the specific row with the chroma pixel positions.

A FIFO 830 receives the luma bitstream from the double buffer and a bitstream of interpolated chroma pixels. The FIFO 830 also receives signals from a bus protocol generator 825 to prepare the luma bitstream and interpolated chroma bitstream for transmission over a bus.

However, as noted above, the pixels of the decoded pictures can have a variety of byte orders, pixel orders, and array formats. In order to interpolate the chroma pixels, the endian select & pixel selection logic 820a places the pixels of the decoded frames into a predetermined byte order, pixel order, and array format prior to storage in the double buffer 840.

Referring now to FIG. 8, there is illustrated a block diagram of the IDWU 820 in accordance with an embodiment of the present invention. The IDWU 820 includes a data path comprising endian swizzle 820a(1), pixel select logic 820a(2), a 32-bit luma pixel register 905Y, a 16-bit chroma red pixel register 905R, and a 16-bit chroma blue pixel register 905B.

The contents of the pixel registers 905 are stored in the double buffer 840. In an exemplary case, the double buffer 840 can include two regions, wherein the contexts of pixel register 905Y are stored in one of the regions, and the contents of pixel registers 905B, and 905R are written together and stored in another region.

Either big endian or little endian byte order can be used for storing the pixels in the double buffer 840. Therefore, the position of each particular pixel within the four bytes depends on whether big endian or little endian byte order is used. For consistent handling, either big endian byte order or little endian order is chosen. Bytes of pixel data in the different or opposite byte order chosen can be reordered. The endian swizzle 820a(1) reverses the ordering of the pixels from either little endian to big endian, or big endian to little endian, when the byte order of the pixels is different or opposite the byte order chosen.

Because the fetched pixels can include a variety of different pixels therein, the pixel select logic 820a(2) directs the pixels to the appropriate pixel registers 905.

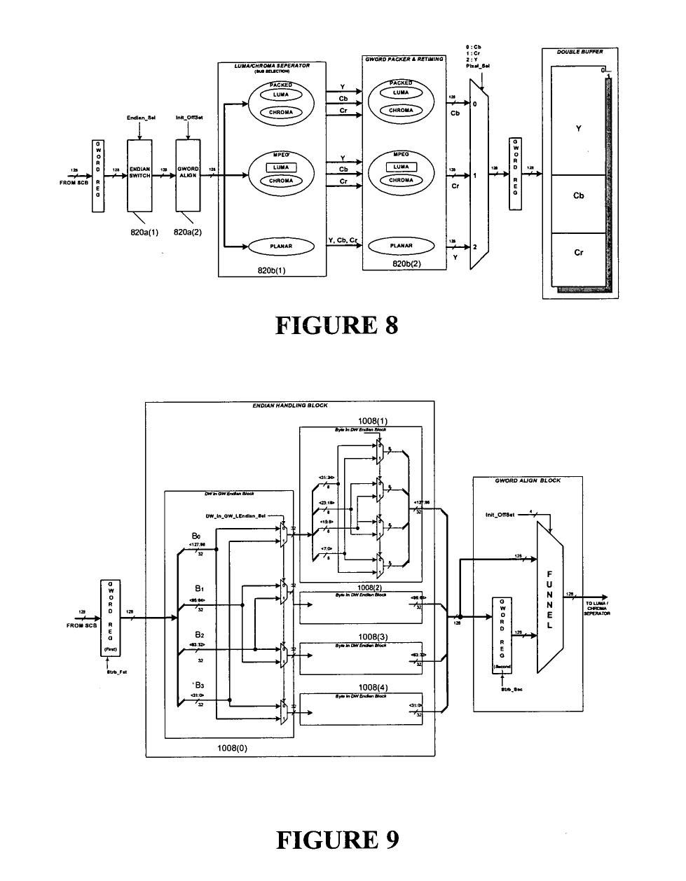

Referring now to FIG. 9, there is illustrated a block diagram of the endian swizzle 820a(1) in accordance with an embodiment of the present invention. The endian swizzle 820a(1) receives the four pixel/32-bit pixel fetches from the IDWU write path 820b. The 32-bit access is demultiplexed into four bytes B₀, B₁, B₂, and B₃, each byte corresponding to a pixel. The endian swizzle 820a(1) includes four multiplexers 1005(0), 1005(1), 1005(2), and 1005(3).

If a different or opposite byte ordering is used for the pixels, then the byte order chosen, B₀ in the original byte order corresponds to B₃ of the chosen byte order. B₁ in the little endian order corresponds to B₂ of the chosen byte order. B₂ in little endian order corresponds to B₁ of the chosen byte order. B₃ in little endian order corresponds to B₀ of the chosen byte order.

Accordingly, multiplexers 1005(0) and 1005(3) receive bytes B₀ and B₃. Multiplexers 1005(1) and 1005(2) receive bytes B_{1 and B}₂. If the original byte order is different or opposite the chosen byte order, bytes B₀ and B₃ are swapped and bytes B_{1 and B}₂ are swapped. Multiplexer 1005(0) selects byte B₃, multiplexer 1005(1) selects byte B₂, multiplexer 1005(2) selects byte B₁, and multiplexer 1005(3) selects byte B₀. The outputs of the multiplexers 1005 are multiplexed to result in the 32-bit access converted to big-endian byte order, e.g., B₃, B₂, B₁, B₀. If the original byte order is the same as the chosen byte order, the byte ordering is maintained. Multiplexer 1005(3) selects byte B₃, multiplexer 1005(2) selects byte B₂, multiplexer 1005(1) selects byte B₁, and multiplexer 1005(0) selects byte B₀. The outputs of the multiplexers 1005 are multiplexed to result in the original 32-bit access, e.g., B₀, B₁, B₂, B₃. The multiplexers 1005 are controlled by a signal Byte_In_DW_Rendian_Sel indicating whether a different or opposite byte order is originally used (1 indicates used, 0 indicates not used, for example) provided by the double buffer read state machine 835f to effectuate the foregoing.

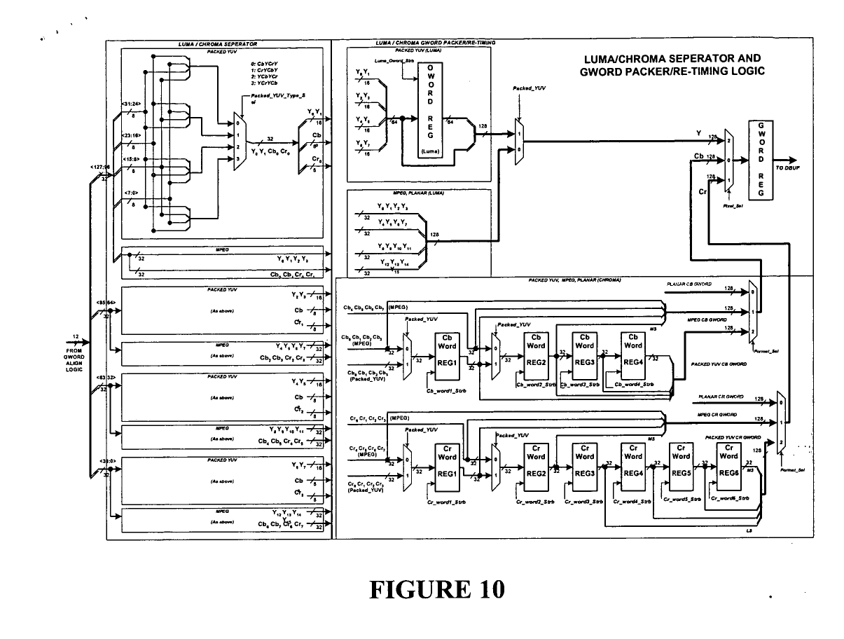

Referring now to FIG. 10, there is illustrated a block diagram of an exemplary pixel separator & Gword packer 820b in accordance with an embodiment of the present invention. The pixel separator & Gword packer 820b comprises a pixel separator 820b(1) and a Gword packer 820b(2).

The pixel separator 820b(1) receives double words B₀, B₁, B₂, and B₃ at stages 820b(1)a, 820b(1)b, 820b(1)c, and 820b(1)d, respectively. The stages 820b(1)a, 820b(1)b, 820b(1)c, and 820b(1)d include a packed YUV circuit and MPEG circuit. Each packed YUV circuit includes a demultiplexers for reordering bytes forming the double words in any one of four different pixel orders, CbYCrY, CrYCbY, YCbYCr, or YCrYCb. The MPEG circuit separates luma pixels from the chroma pixels.

The Gword packer 820b(2) includes a MPEG luma/chroma packer, planar luma/chroma Cb/chroma Cr packer, and a packed YUV luma & chroma packer. The MPEG luma packer packs 16 luma pixels into a Gword register and MPEG chroma packer packs 8 chroma Cb & 8 chroma Cr pixels in another Gword register, when the format is MPEG. The planar luma packer packes 16 luma pixels into the Gword register and planar chroma packer packs 16 chroma Cb pixels into another Gword register and 16 chroma Cr pixels into separate Gword register, when the format is Planar. The packed YUV Gword packer packs 8 pixels of luma, 4 pixels of chroma Cb and 4 pixels of chroma Cr into the Gword register, when the format is packed YUV. The packed YUV, MPEG, Planar Chroma packer includes a Cb word register and a Cr word register for storing pixels over more than one access.

One embodiment of the present invention may be implemented as a board level product, as a single chip, application specific integrated circuit (ASIC), or with varying levels integrated on a single chip with other portions of the system as separate components.

The degree of integration of the system will primarily be determined by speed and cost considerations. Because of the sophisticated nature of modern processors, it is possible to utilize a commercially available processor, which may be implemented external to an ASIC implementation of the present system.

Alternatively, if the processor is available as an ASIC core or logic block, then the commercially available processor can be implemented as part of an ASIC device with various functions implemented as firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope.

Therefore, it is intended that the invention not be limited to the particular embodiment(s) disclosed, but that the invention will include all embodiments falling within the scope of the appended claims.

1. A method for displaying pictures, said method comprising:
fetching a portion of a picture being stored in a frame buffer, the portion of the picture stored with a byte order;
converting the byte order of the portion of the picture to a predetermined byte order, the byte order being different from the predetermined byte order; and
storing the portion of the picture in another buffer with the predetermined byte order.

2. The method of claim 1, wherein the predetermined order is selected from a group consisting of big endian byte order and little endian byte order.

3. The method of claim 1, further comprising:
providing an indicator indicating whether the byte order is different or opposite from the predetermined order.

4. The method of claim 3, further comprising:
swapping a first pixel from the portion of the picture and a second pixel from the portion of the picture if the indicator indicates that the byte order is different or opposite from the predetermined order; and
swapping a third pixel from the portion of the picture and a fourth pixel from the portion of the picture if the indicator indicates that the byte order is different or opposite from the predetermined order.

5. A system for displaying pictures, said system comprising:
a first circuit for fetching a portion of a picture stored in a frame buffer, the portion of the picture being stored with a byte order;
a second circuit for converting the byte order of the portion of the picture to a predetermined byte order, the byte order being different from the predetermined byte order; and
a buffer for storing the portion of the picture with the predetermined byte order.

6. The system of claim 5, wherein the predetermined order is selected from a group consisting of big endian byte order and little endian byte order.

7. The system of claim 5, further comprising:
a state machine for providing an indicator indicating whether the byte order is different or opposite from the predetermined order to the second circuit.

8. The system of claim 7, wherein the second circuit further comprises:
a first multiplexer for selecting one of a first pixel of the portion of the picture and a second pixel of the portion of the picture;
a second multiplexer for selecting another of the first pixel of the portion of the picture and a second pixel of the portion of the picture, from the first multiplexer;
a third multiplexer for selecting one of a third pixel of the portion of the picture and a fourth pixel of the portion of the picture;
a fourth multiplexer for selecting another of the third pixel of the portion of the picture and the fourth pixel of the portion of the picture, from the third multiplexer;
a fifth multiplexer for multiplexing outputs from the first multiplexer, the second multiplexer, the third multiplexer, and fourth multiplexer; and
the selections of the first multiplexer, the second multiplexer, the third multiplexer, and the fourth multiplexer being controlled by the indicator provided by the state machine.

9. A method for displaying pictures, said method comprising:
fetching a portion of a picture stored in a frame buffer, the portion of the picture being stored with a pixel order;
converting the pixel order of the portion of the picture to a predetermined pixel order; and
storing the portion of the picture in another buffer with the predetermined pixel order.

10. The method of claim 9, further comprising:
rearranging a plurality of pixels from the portion of the picture in a plurality of different pixel orders;
receiving an indicator indicating the pixel order; and
selecting the pixels rearranged in one of the plurality of different pixel orders based on the indicator indicating the pixel order.

11. A system for displaying pictures, said system comprising:
an input data write unit for fetching a portion of a picture stored in a frame buffer, the portion of the picture being stored with a pixel order;
a circuit for converting the pixel order of the portion of the decoded picture to a predetermined pixel order; and
a buffer for storing the portion of the picture with the predetermined pixel order.

12. The system of claim 11, wherein the circuit further comprises:
a demultiplexer for separating a plurality of pixels from the portion of the picture;
a plurality of multiplexers for combining the separated plurality of pixels in a corresponding plurality of pixel orders; and
another multiplexer for selecting an output from one of the plurality of multiplexers, based on an indicator indicating the pixel order provided by the state machine.

13. A method for displaying pictures, said method comprising:
fetching a portion of a picture stored in a frame buffer, said portion of the picture comprising a plurality of pixels;
storing luma pixels in a luma pixel register, if the plurality of pixels comprise luma pixels;
storing chroma pixels in a chroma pixel register, if the plurality of pixels comprise chroma pixels; and
storing the contents of the chroma pixel register in one portion of another buffer and the contents of the luma pixel register in another portion of the another buffer.

14. The method of claim 13, wherein storing the luma pixels in the luma pixel register further comprises:
receiving the plurality of pixels; and
providing the luma pixels to the luma pixel register, if the plurality of pixels comprise luma pixels.

15. The method of claim 13, wherein storing the luma pixels in the luma pixel register further comprises:
receiving the plurality of pixels over a first path;
receiving a portion of the plurality of pixels over a second path;
selecting the plurality of pixels from the first path, if all of the plurality of pixels are luma pixels; and
selecting the portion of the plurality of pixels from the second path, if a portion of the plurality of pixels are luma pixels and another portion of the plurality of pixels are chroma pixels.

16. The method of claim 13, wherein storing chroma pixels in the chroma pixel register further comprises:
receiving the plurality of pixels; and
providing the chroma pixels to the chroma pixel register, if the plurality of pixels comprise chroma pixels.

17. The method of claim 13, wherein storing the chroma pixels in the chroma pixel register further comprises:
receiving the plurality of pixels over a first path;
receiving a portion of the plurality of pixels over a second path;
selecting the plurality of pixels from the first path, if all of the plurality of pixels are chroma pixels; and
selecting the portion of the plurality of pixels from the second path, if a portion of the plurality of pixels are chroma pixels and another portion of the plurality of pixels are luma pixels.

18. The method of claim 13, wherein storing chroma pixels in the chroma pixel register further comprises:
receiving the plurality of pixels;
providing chroma Cr pixels to a chroma Cr pixel register, if the plurality of pixels comprise chroma Cr pixels; and
providing chroma Cb pixels to a chroma Cb pixel register, if the plurality of pixels comprise chroma Cb pixels.

19. The method of claim 13, wherein storing the chroma pixels in the chroma pixel register further comprises:
receiving the plurality of pixels over a first path;
receiving a portion of the plurality of pixels over a second path;
selecting the plurality of pixels from the first path, if all of the plurality of pixels are chroma pixels; and
selecting the portion of the plurality of pixels from the second path, if a portion of the plurality of pixels are chroma pixels and another portion of the plurality of pixels are luma pixels.

20. The method of claim 19, further comprising:
storing at least one of the plurality of pixels in a chroma Cr pixel register, if the plurality of pixels are selected;
storing at least one of the plurality of pixels in a chroma Cb pixel register, if the plurality of pixels are selected;
storing at least one of the pixels from the portion of the plurality of pixels from the second path in the chroma Cr pixel register, if the portion of the plurality of pixels are selected; and
storing at least one of the pixels from the portion of the plurality of pixels from the second path in the chroma Cb pixel register, if the portion of the plurality of pixels are selected.

21. A system for displaying pictures, said system comprising:
a first circuit for fetching a portion of a picture stored in a frame buffer, the portion of the picture comprising a plurality of pixels;
a luma pixel register for storing luma pixels, if the plurality of pixels comprise luma pixels;
a chroma pixel register for storing chroma pixels, if the plurality of pixels comprise chroma pixels; and
another buffer for storing the portion of the picture.

22. The system of claim 21, further comprising:
a first multiplexer for receiving a first portion of the plurality of pixels over a first path, and for receiving a second portion of the plurality of pixels over a second path, the first multiplexer associated with a first portion of the luma pixel register;
a second multiplexer for receiving a remainder of the plurality of pixels from the first portion of the plurality of pixels over a first path, and for receiving the second portion of the plurality of pixels, the second multiplexer associated with a second portion of the luma pixel register; and
the first multiplexer provides the portion of the plurality of pixels to the first portion of the luma pixel register and the second multiplexer provides the remainder of the plurality of the pixels to the second portion of the luma pixel register if the portion of the plurality of pixels and the remainder of the plurality of pixels comprise luma pixels;
the state machine selects one of the first multiplexer and the second multiplexer, the selected one of the multiplexers providing the second portion of the pixels to the associated portion of the luma pixel register, if the plurality of pixels comprise luma and chroma pixels.

23. The system of claim 21, further comprising:
a first multiplexer for receiving a first portion of the plurality of pixels over a first path, and for receiving a second portion of the plurality of pixels over a second path, the first multiplexer associated with a first portion of the chroma pixel register;
a second multiplexer for receiving a remainder of the plurality of pixels from the first portion of the plurality of pixels over a first path, and for receiving the second portion of the plurality of pixels, the second multiplexer associated with a second portion of the chroma pixel register; and
the first multiplexer provides the portion of the plurality of pixels to the first portion of the luma pixel registers and the second multiplexer provides the remainder of the plurality of the pixels to the second portion of the luma pixel register if the portion of the plurality of pixels and the remainder of the plurality of pixels comprise chroma pixels;
the state machine selects one of the first multiplexer and the second multiplexer, the selected one of the multiplexers providing the second portion of the plurality of pixels to the associated portion of the luma pixel register, if the plurality of pixels comprise luma and chroma pixels.
